(19) United States
(12) Patent Application Publication
(10) Pub. No.: US 2011/0269058 A1
(43) Pub. Date: Nov. 3, 2011

(54) SOLID OXIDE FUEL CELL AND METHOD OF MANUFACTURING THE SAME

(75) Inventor: Jeong-Doo Yi, Yongin-si (KR)

(73) Assignee: Samsung SDI Co., Ltd., Yongin-si (KR)

(21) Appl. No.: 12/958,079

(22) Filed: Dec. 1, 2010

(30) Foreign Application Priority Data
Apr. 29, 2010 (KR) 10-2010-0039971

(51) Int. Cl. H01M 4/75; H01M 8/10

(52) U.S. Cl. 429/495; 429/535

(57) ABSTRACT

In a method of manufacturing an SOFC, a cathode current-collecting wire is spirally wound around the outer circumferential surface of a unit cell having a cylindrical anode, a cylindrical electrolyte and a cylindrical cathode, sequentially stacked therein. In the method, the length of a portion at which the cathode current-collecting wire is wound is shorter than that of a portion at which the cathode is formed. Accordingly, the stability of the SOFC can be improved by preventing a phenomenon that the SOFC is shorted due to the breakdown of an electrolyte in the operation of the SOFC.

### CROSS-REFERENCE TO RELATED APPLICATION

This application claims the benefit of Korean Patent Application No. 10-2010-0039971, filed Apr. 29, 2010 in the Korean. Intellectual Property Office, the disclosure of which is incorporated herein by reference.

### BACKGROUND

1. Field

Aspects of the present invention relates to a fuel cell, and more particularly, to an anode supported solid oxide fuel cell and a method of manufacturing the same.

2. Description of the Related Art

Fuel cells are a class of high-efficiency, clean generation technology that directly convert hydrogen and oxygen into electric energy through an electrochemical reaction. The hydrogen is contained in a hydrocarbon-based material such as natural gas, coal gas or methanol. The oxygen is contained in the air. Such fuel cells are classified into an alkaline fuel cell (AFC), a phosphoric acid fuel cell (PAFC), a molten carbonate fuel cell (MCFC), a solid oxide fuel cell (SOFC) and a polymer electrolyte membrane fuel cell (PEMFC), depending on the kind of an electrolyte used.

Generally, the PAFC, MCFC and SOFC are referred to as first-, second- and third-generation fuel cells, respectively. The PAFC is a first generation fuel cell using a fuel and a phosphoric acid electrolyte. Here, the fuel includes hydrogen gas containing hydrogen as a main element and oxygen in the air. The MCFC is a second generation fuel cell operated at about 650° C. by using a molten salt as an electrolyte. The SOFC is a third generation fuel cell operated at the highest temperature to generate electricity at the highest efficiency among these fuel cells.

The development of the SOFC started later than that of the PAFC and the MCFC. However, with the rapid development of material technology, the SOFC in succession to the PAFC and the MCFC will be put to practical use in a short period of time. To this end, many efforts have been made to conduct basic studies on SOFCs and to develop technology for large-sized SOFCs.

The SOFC is a fuel cell operated at a high temperature of about 600 to 1000° C. The SOFC has the highest efficiency and the lowest pollution among various types of fuel cells. In the SOFC, a fuel reformer is not required, and combined power generation is possible.

The SOFC is divided into two types: a tube type and a flat plate type. Between the tube and flat plate types, the tube type is estimated to have a lower power density within a stack than the power density of a stack in the flat plate type. However, the tube type has an entire power density of the entire system that is similar to the entire power density of a system in the flat plate type.

The tube type is an advanced technique for manufacturing large-area fuel cells because unit cells constituting a stack are easily sealed, resistance for thermal stress is strong, and the mechanical strength of the stack is high. Thus, studies on the tube type have been actively conducted. Also, tube-type SOFCs are divided into two types of fuel cells: a cathode supported fuel cell using a cathode as a support thereof and an anode supported fuel cell using an anode as a support thereof. Between the two types, the anode supported fuel cell is an advanced type, and anode supported fuel cells are studied and developed as current SOFCs.

The anode supported tube-type SOFC is a tubular structure having various sectional shapes such as a cylinder shape and a flat plate shape. An electrolyte and a cathode are sequentially stacked on an outer surface of an anode-supported tube. Electricity generated from the fuel cell makes an external circuit work while flowing through the external circuit. In this case, current collectors for supplying the electricity generated from the fuel cell to an external device or circuit are formed on the inner circumferential surface of the anode and the outer circumferential surface of the cathode, respectively. Generally, there are various methods for current collection of the anode and cathode. As an anode current-collecting method, current is collected by inserting a current collector into the fuel cell from the exterior of the fuel cell using a metal tube. As a cathode current-collecting method, current is collected using a wire or the like. In the manufacturing of the fuel cell, the electrolyte serves as a region in which oxygen ions are moved, and operational characteristics of the SOFC are determined by the thickness of the electrolyte.

When the electrolyte is formed to be thin, the resistance of the electrolyte is decreased, which increases the movement of the oxygen ions and thereby improving the operational characteristics. However, the mechanical strength of the electrolyte is decreased, which causes a problem in stability. In contrast, when the electrolyte is formed to be thick because of the problem of stability, the mechanical strength of the electrolyte is increased, but the movement of the oxygen ions is decreased which reduces the output power of the fuel cell.

The thickness of electrolytes currently used widely is about a few tens of micrometers (μm). In the manufacturing of an electrolyte, a variation in the thickness of the electrolyte exists, and cracks occur at a portion weak to a mechanical strength when a fuel cell is driven. At this time, an internal anode and an external cathode current collector are electrically connected to each other through the cracks, and therefore, current flows through the cracks.

### SUMMARY

In one or more embodiments, there are provided a solid oxide fuel cell (SOFC) and a method of manufacturing the same, which can improve the stability of the SOFC by preventing a phenomenon that the SOFC is shorted due to the breakdown of an electrolyte in the operation of the SOFC.

In one or more embodiments, there are provided an SOFC and a method of manufacturing the same, in which the winding of a wire, performed around the outer circumferential surface of a cathode, is performed around only the inner circumferential surface of the cathode, thereby reducing the breakdown of an electrolyte and minimizing performance loss.

According to an aspect of the present invention, there is provided an SOFC including: a unit cell in which an anode, an electrolyte and a cathode are sequentially stacked, and electricity is generated through an electrochemical reaction of hydrogen supplied from the anode and oxygen supplied from the cathode; and an anode current collector and a cathode current-collecting wire respectively connected to the anode and the cathode so as to supply the electricity generated in the unit cell to an external device or circuit. In the SOFC, the cathode current-collecting wire is spirally wound around the outer circumferential surface of the cathode, and the length of the cathode current-collecting wire wounded around the outer circumferential surface of the cathode is at least shorter than that of a portion at which the cathode is formed. The cathode current-collecting wire.

According to an aspect of the present invention, the distance from both ends of the cathode to the portion at which the winding of the cathode current-collecting wire is finished may be less than two times smaller than that at which the cathode current-collecting wire is wound.

According to an aspect of the present invention, the period at which the cathode current-collecting wire is wound at one side of the cathode may be different from the period at which the cathode current-collecting wire is wound at the other side of the cathode.

According to an aspect of the present invention, the period at which the cathode current-collecting wire is wound at one side of the cathode may be identical to the period at which the cathode current-collecting wire is wound at the other side of the cathode.

According to an aspect of the present invention, the period at which the cathode current-collecting wire is wound at a side at which hydrogen is injected into the anode may be longer than that at which the cathode current-collecting wire is wound at the opposite side to the side at which the hydrogen is injected into the anode.

According to an aspect of the present invention, the period at which the cathode current-collecting wire is wound may be gradually decreased in the direction in which the hydrogen is exhausted from the side at which the hydrogen is injected into the anode.

According to an aspect of the present invention, the period at which the cathode current-collecting wire is wound may be decreased at a rate of less than 17% every 10 cm.

According to an aspect of the present invention, a metal with the shape of a wire, stick, pipe or tube may be inserted as an anode collector into in the interior of the anode.

According to an aspect of the present invention, the anode collector may be tightly adhered and fixed to the inner circumferential surface of the anode by a separate tube formed in the interior of the anode

According to an aspect of the present invention, the unit cell may be an anode supported fuel cell.

According to an aspect of the present invention, there is provided a method of manufacturing an SOFC, in which a cathode current-collecting wire is spirally wound around the outer circumferential surface of a unit cell having a cylindrical anode, a cylindrical electrolyte and a cylindrical cathode, sequentially stacked therein, wherein the length of a portion at which the cathode current-collecting wire is wound is shorter than that of a portion at which the cathode is formed.

According to an aspect of the present invention, the distance from both ends of the cathode to the portion at which the winding of the cathode current-collecting wire is finished may be less than two times smaller than that at which the cathode current-collecting wire is wound.

According to an aspect of the present invention, the period at which the cathode current-collecting wire is wound at a side at which hydrogen is injected into the anode may be longer than that at which the cathode current-collecting wire is wound at the opposite side to the side at which the hydrogen is injected into the anode.

According to an aspect of the present invention, the period at which the cathode current-collecting wire is wound may be gradually decreased in the direction in which the hydrogen is exhausted from the side at which the hydrogen is injected into the anode.

According to an aspect of the present invention, the period at which the cathode current-collecting wire is wound may be decreased at a rate of less than 17% every 10 cm.

In an SOFC according to an embodiment of the present invention, the stability of the SOFC can be improved by preventing a phenomenon that the SOFC is shorted due to the breakdown of an electrolyte in the operation of the SOFC.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a sectional view showing the structure of a cylinder type solid oxide fuel cell (SOFC) according to an embodiment of the present invention.

FIGS. 2 and 3 are views showing the structure of a cathode current-collecting wire according to an embodiment of the present invention.

FIG. 4 is a graph showing the distribution of the concentration of hydrogen and the concentration of current based on the distance from a portion at which the hydrogen is supplied in a general cylinder type SOFC.

FIG. 5 is a view showing the structure of a cathode current-collecting wire according to an embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

It will be understood that although the terms first and second are used herein to describe various components, but these components should not be limited by these terms. These terms are only used to distinguish one component from another component. The terminology used in the description of the invention herein is for the purpose of describing particular embodiments only and is not intended to be limiting of the invention. The singular forms are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

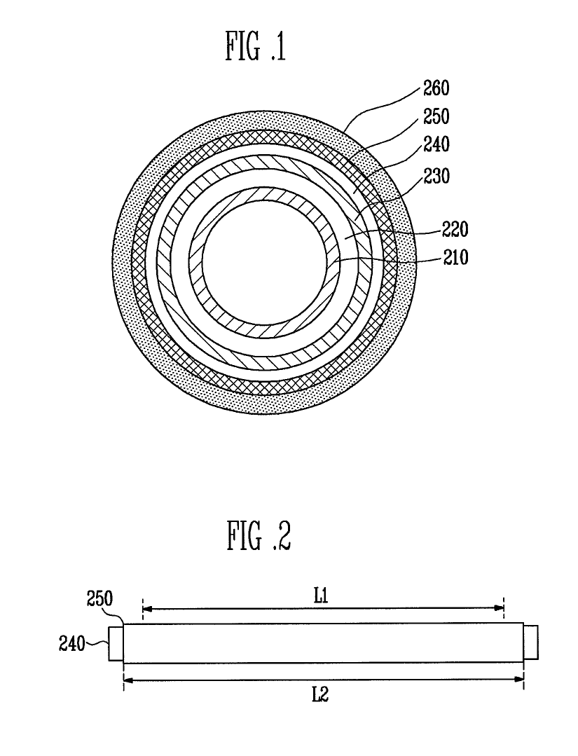

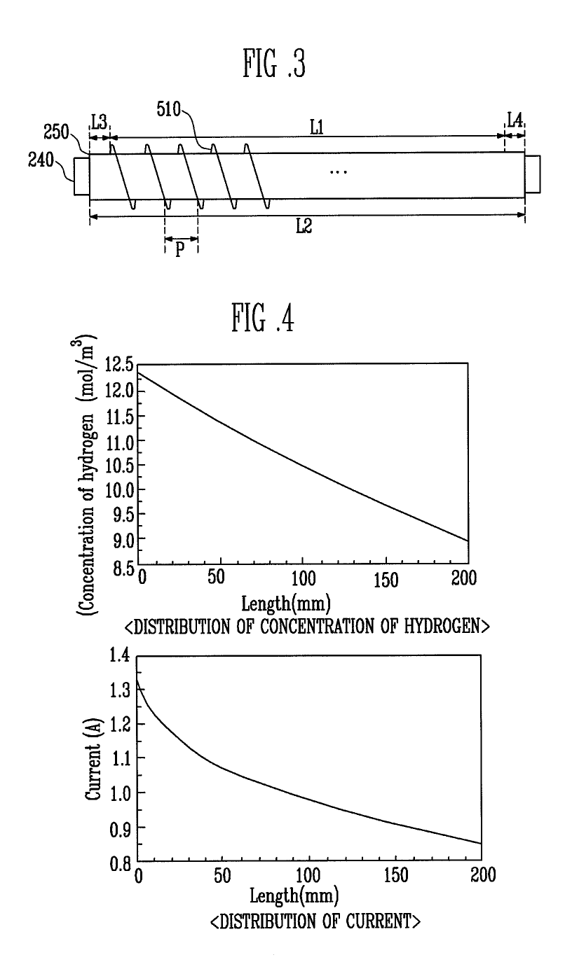

FIG. 1 is a sectional view showing the structure of a cylinder type solid oxide fuel cell (SOFC) according to an embodiment of the present invention. FIGS. 2 and 3 are views showing an embodiment of a cathode current-collecting wire 510 formed on an outer circumferential surface of the cathode 250 according to an embodiment of the present invention. The cylinder type SOFC includes a unit cell formed by sequentially stacking an anode 230, an electrolyte 240 and the cathode 250, formed in a cylindrical shape. In the unit cell, electricity is generated through an electrochemical reaction of hydrogen supplied from the anode 230 and oxygen supplied from the cathode 250.

An anode current collector 220 is formed on the inner circumferential surface of the anode 230. A cathode current collector 260 is formed on the outer circumferential surface of the cathode 250, so that the electricity generated in the unit cell is supplied to an external device or circuit (not shown) through the anode current collector 220 and the cathode current collector 260.

According to the embodiment of the present invention, as shown in FIGS. 2 and 3, the cathode current collector 260 is formed in the shape of the cathode current-collecting wire 510 spirally wound around the outer circumferential surface of the cathode 250. How to wind such a wire 510 is one of factors to be significantly considered so as to enhance the current collection and performance of the SOFC. The method of winding the cathode current-collecting wire will be described in detail later. While described in terms of being a wire, it is understood that the wire is not restricted to a particular cross sectional shape, and can be round, oval, rectangular, or need not have a consistent cross sectional shape in all aspects of the invention. Further, in other aspects, the cathode current-collector wire 510 could also be implemented using strips or other shaped materials capable of being wound about the cathode 250.

The anode current collector 220 may be formed on the inner circumferential surface of the anode 230 by inserting various types of metallic materials such as a wire, a stick, a metal pipe and a tube into the interior of the anode 230. As shown in FIG. 1, the anode current collector 220 can be tightly adhered and fixed to the inner circumferential surface of the anode 230 by a metal tube 210 or the like, formed in the interior of the anode 230. The various types of metallic materials are inserted into the interior of the anode 230, so that anode current collection can be performed, and the strength of the SOFC can be increased. Examples of the metallic materials include a wire, a stick, a metal pipe and a tube.

Also, the separate metal tube 210 or the like are inserted into the interior of the anode current collector 220, so that the anode current collector 220 can be more tightly adhered and fixed to the inner circumferential surface of the anode 230, and the strength of the SOFC can be increased.

However, the strength of the winding of the wire 510 may be increased so as to improve characteristics of current collection when the winding of the wire 510 is performed. When the strength of the winding of the wire 510 is increased, the contact property between the wire 510 and the unit cell is also increased. In contrast, when the winding of the wire 510 is excessively extended to the electrolyte 240, the electrolyte 240 may be easily broken down because the electrolyte 240 is formed to be too thin. The breakdown of the electrolyte 240 may occur in the sate that the anode 230 and the cathode 250 are not completely separated from each other, and therefore, the function of the SOFC is not sufficiently performed. Accordingly, which region between the cathode 250 and the electrolyte 240 in which the winding of the wire 510 is performed and the strength of the winding of the wire 510 are significant factors among all of the factors to be considered in the manufacture of the fuel cell.

FIGS. 2 and 3 are views showing the structure of the cathode current-collecting wire 510 according to an embodiment of the present invention. Referring to FIG. 2, the cathode 250 is formed at the exterior of a unit cell. While not required in all aspects, a portion of the electrolyte 240 formed in the interior of the cathode 250 is exposed. At this time, the cathode current-collecting wire 510 is formed on the outer circumferential surface of the cathode 250. The length L1 of the cathode current-collecting wire 510 wound around the outer circumferential surface of the cathode 250 (i.e., a portion at which the winding of the cathode current-collecting wire 510 is finished) is shown as being shorter than the length L2 of the cathode 250 formed at the exterior of the unit cell (L1≦L2), although the invention is not limited thereto. The distance between each end of the cathode 250 to the portion around which the cathode current-collecting wire 510 is would is L3 or L4. As such, L2=L1+L3+L4.

Particularly, referring to FIG. 3, the distance (L3 and L4) from both ends of the cathode 250 to the portion at which the cathode current-collecting wire 510 is wound (i.e., to the portion at which the winding of the cathode current-collecting wire 510 is finished) may be less than two times smaller than the period P at which the cathode current-collecting wire 510 is wound (i.e., P≧2L3 or 2L4). However, the invention is not limited thereto.

When the contact property between the cathode current-collecting wire 510 and the unit cell is increased by increasing the strength of the cathode current-collecting wire 510 so as to improve the characteristics of current collection, the cathode current-collecting wire 510 may be excessively extended to the electrolyte 240. When the electrolyte 240 is broken down because it is formed to be thin, the anode and the cathode 250 are not completely separated from each other, and therefore, the function of the SOFC is not sufficiently performed. To solve such a problem, the cathode current-collecting wire 510 is formed only in the interior of the cathode 250, thereby reducing the breakdown of the electrolyte and minimizing the degradation of performance. While shown as having both L3 and L4 greater than zero, it is understood that aspects of the invention are not limited thereto.

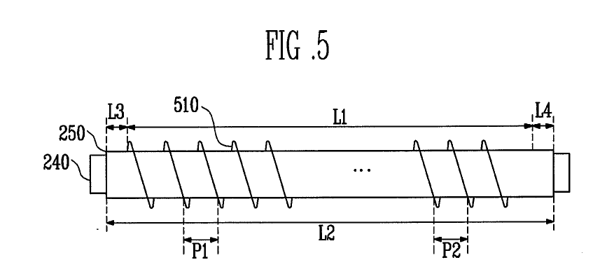

FIG. 4 is a graph showing the distribution of the concentration of hydrogen and the concentration of current based on the distance from a portion at which the hydrogen is supplied in a general cylinder type SOFC. Referring to FIG. 4, as the length is distant from the portion at which hydrogen is injected into the unit cell, the concentration of hydrogen is decreased, and current is also decreased. According to the present invention, the period P at which the cathode current-collecting wire 510 is wound may be changed depending on the direction in which the hydrogen is injected into the unit cell.

FIG. 5 is a view showing the structure of a cathode current-collecting wire 510 according to an embodiment of the present invention. Referring to FIGS. 1 and 5, assuming that the hydrogen is injected into the unit cell from a left side of the unit cell, the cathode current-collecting wire 510 has two periods P1 and P2, depending on a distance from the left side. Specifically, the period P1 at which the hydrogen is injected into the anode 230 is longer than the period P2 at the opposite side to the side at which the hydrogen is injected into the anode 230. Thus, the period decreases as a function of distance from the side at which hydrogen is introduced to account for the decrease in hydrogen and current concentration the farther the location from the side. In this way, the current collection can be relatively uniform over the length of the fuel cell unit.

While shown as having only two periods P1 and P2 for purposes of simplicity, it is understood that aspects are not limited thereto. According to an aspect of the invention, the period at which the cathode current-collecting wire 510 is wound may be sequentially decreased between P1 and P2. For example, the cathode current-collecting wire 510 may be formed so that a period is gradually decreased from the left side of the unit cell to the right side of the unit cell. In the period, the cathode current-collecting wire 510 is wound in the direction in which the hydrogen is exhausted from the side at which the hydrogen is injected. At this time, the rate at which the period is decreased is determined as less than 17% every 10 cm with reference to the rate at which current is decreased in FIG. 5. Accordingly, the cathode current-collecting wire 510 can be wound at the rate described above. However, the invention is not limited thereto, and it is understood that the direction of the wire winding can be reversed in other aspects, such as where the hydrogen is introduced from the right side as opposed to the left side as shown. Alternately, while described in terms of a linear change, it is understood that the decrease could be non-linear, such as by matching the current density decrease shown in FIG. 4.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A solid oxide fuel cell (SOFC) comprising a unit cell, the unit cell comprising:
an anode;
a cathode;
an electrolyte disposed between the anode and the cathode; and
a current collector comprising a cathode current-collecting wire spirally wound around an outer circumferential surface of the cathode,
wherein a length of the outer circumferential surface of the cathode at a portion about which the cathode current-collecting wire is wound is less than a length of an entire outer circumferential surface of the cathode.

2. The SOFC according to claim 1, wherein a distance from each end of the cathode to the portion about which the winding of the cathode current-collecting wire is wound is less than two times smaller than a period at which the cathode current-collecting wire is wound.

3. The SOFC according to claim 1, wherein a period at which the cathode current-collecting wire is wound at one side of the cathode is different from a period at which the cathode current-collecting wire is wound at another side of the cathode.

4. The SOFC according to claim 1, wherein a period at which the cathode current-collecting wire is wound at one side of the cathode is the same as a period at which the cathode current-collecting wire is wound at another side of the cathode.

5. The SOFC according to claim 3, wherein the period at which the cathode current-collecting wire is wound at a side at which hydrogen is injected into the anode is longer than the period at which the cathode current-collecting wire is wound at a side opposite to the side at which the hydrogen is injected into the anode.

6. The SOFC according to claim 5, wherein the period at which the cathode current-collecting wire is wound is gradually decreased in a direction in which the hydrogen is exhausted from the side at which the hydrogen is injected into the anode.

7. The SOFC according to claim 6, wherein the period at which the cathode current-collecting wire is wound is decreased at a rate of less than 17% every 10 cm.

8. The SOFC according to claim 1, further comprising an anode current collector inserted in an interior of the anode such that the anode is between the electrolyte and the anode current collector, the anode current collector comprising a metal with a shape of a wire, a stick, a pipe, and/or a tube.

9. The SOFC according to claim 8, further comprising a tube formed in the interior of the anode, wherein the anode collector is tightly adhered and fixed to an inner circumferential surface of the anode by the tube.

10. The SOFC according to claim 1, wherein the unit cell is formed in a cylinder shape.

11. The SOFC according to claim 1, wherein the unit cell comprises an anode supported fuel cell.

12. A method of manufacturing a solid oxide fuel cell (SOFC), the method comprising:
spirally winding a cathode current-collecting wire around an outer circumferential surface of a unit cell having a cylindrical anode, a cylindrical cathode, and a cylindrical electrolyte disposed between the anode and cathode; and
not spirally winding the cathode current-collecting wire on a portion of the unit cell such that a length of a winding portion about which the cathode current-collecting wire is wound is shorter than that of a length of the cathode.

13. The method according to claim 12, wherein:
the spirally winding comprises spirally winding the cathode current-collecting wire at a period, and
a distance from each end of the cathode to the winding portion is less than two times smaller than the period at which the cathode current-collecting wire is wound.

14. The method according to claim 13, wherein the spirally winding comprises winding the cathode current-collecting wire at a side at which hydrogen is injected into the anode using a first period which is longer than that a second period at which the cathode current-collecting wire is wound at an opposite side to the side at which the hydrogen is injected into the anode.

15. The method according to claim 14, wherein the spirally winding comprises winding comprises gradually decreasing the period between the first and second periods in a direction in which the hydrogen is exhausted from the side at which the hydrogen is injected into the anode.

16. The method according to claim 15, wherein the period at which the cathode current-collecting wire is wound is decreased at a rate of less than 17% every 10 cm.
